(19) United States
(12) Patent Application Publication
(10) Pub. No.: US 2005/0273314 A1
(43) Pub. Date: Dec. 8, 2005

(54) Method for processing Chinese natural language sentence

(75) Inventors: Feng-Lin Chang, Taipei (TW); Yi-Chun Chen, Taipei (TW); Hua-Sen Cheng, Taipei (TW)

Correspondence Address: BACON & THOMAS, PLLC, 625 SLATERS LANE, FOURTH FLOOR, ALEXANDRIA, VA, 22314, US

(73) Assignee: SimpleAct Incorporated, Taipei (TW)

(21) Appl. No.: 10/861,484

(22) Filed: Jun. 7, 2004

(51) Int. Cl. G06F 17/28

(52) U.S. Cl. 704/4

(57) ABSTRACT

A method for processing natural language Chinese sentences can transform a Chinese sentence into a Triple representation using shallow parsing techniques. The method is concerned with parsing Chinese sentences by employing lexical and syntactical information to extract more prominent entities in a Chinese sentence, and the sentence is then transformed into a Triple representation by employing the Triple rules referring to elemental Chinese syntax—SVO (subject, verb, and object in order). The lexical and syntactical information in our method is referring a lexicon possessed of part-of-speech (POS) information and phrase-level syntax in Chinese respectively. The Triple representation consists of three elements which are agent, predicate, and patient in a sentence.

### BACKGROUND OF THE INVENTION

Natural language is one of the fundamental aspects human behaviors and is an essential component of our lives. Human beings learn language by discovering patterns and templates, which are used to put together a sentence, a question, or a command. Natural language processing/understanding (NLP/U) assumes that if we can define those patterns and describe them to a computer then we can teach a machine something of how we understand and communicate with each other. This work is based on research in a wide range of area, most importantly computer science, linguistics, logic, psycholinguistics, and the philosophy of language. These difference disciplines define their own set of problems and the methods for addressing them. The linguisticians, for instance, study the structure of language itself and consider questions such as why certain combinations of words from sentences but other do not. The philosophers consider how words can mean anything at all and how they identify objects in the world. The goal of computational linguistic is to develop a computational theory of language, using the notions of algorithms and data structures from computer science. To build a computational model, one must take advantage of what is known from all the other disciplines.

There are many applications of natural language understanding that researchers work on. The applications of natural language understanding can be divided into two major classes: text-based applications and dialogue-based applications.

Text-based applications involve the processing of written text, such as newspapers, reports, manuals etc. These kinds of texts are reading-based. The text-based natural language research is ongoing in applications listed below:
Information Retrieval/Extraction (IR/E)—retrieving appropriate documents or text segments from a text database, or extracting information from texts on certain topics
Text classification/categorization—the task of assigning predefined class (category) labels to free text documents (This application may exploit some methods from information extraction.)
Automatic summarization—summarizing texts for certain purpose
Machine translation—translating from one language to another or helping human to do the work of translation
Auto-annotation (tagging)—annotating specific words, phrases, or sentences of an unstructured document and making it contain semantic knowledge or a structured document

Dialogue-based applications involve communication between humans and computers. It involves spoken language, that is, humans may use microphone or keyboards to interact and communicate with computer. These applications include:
Question-answering systems—using natural language to query a database
Automated customer service—automated customer service over telephone, e-mail, or fax
Tutoring system—utilizing a computer to be a tutor to interact with a student
Voice control system—spoken language control of a machine

The essential task of performing these applications is to analyze or parse texts in the database of a system and the text users input. That is, we have to process each sentence systematically and effectively. Most traditional approach to parse natural language sentences aim to recover complete, exact parses based on the integration of complex syntactic and semantic information. They search through the entire space of parses defined by the grammar and then seek the globally best parse referring to some heuristic rules or manual correction. For example, the sentence (1a) taken from Sinica Treebank (Sinica Treebank, 2002) is annotated as (1b).

| | | |
|---|---|---|
| (1) a. | [symbol] | (Chinese) |
| | ta zhongyu zhaodao yifen gongzuo le | (Pin Yin) |
| | he final find a job | (word-to-word) |
| | He finally found a job. | (English) |

| | |
|---|---|
| b. | S(agent:NP(Head:Nhaa: [symbol] )\|time:Dd: [symbol] \|Head:VC2: [symbol] \|goal: |
| | NP(quantifier: DM: [symbol] \|Head:Nac: [symbol] )\|particle:Ta: [symbol] ) |
| | S(agent:NP(Head:Nhaa:he)\|time:Dd:finally\|Head:VC2:find\| |
| | goal:NP(quantifier:DM:a\|Head:Nac:job)\|particle:Ta:le) |

The sentence structure in Sinica Treebank is represented by employing head-driven principle, that is, each sentence or phrase has a head leading it. A phrase consists of a head, arguments and adjuncts. One can use the concept of head to figure out the relationship among the phrases in a sentence. In the example (1), the head of the NP (noun phrase), [symbol] ‘he,’ is the agent of the verb, [symbol] ‘find’. Although the head-driven principle may prevent the ambiguity of syntactical analysis (Chen et al., 1999), to choose the head of a phrase automatically may cause errors. Another example (2) is extracted from the Penn Chinese TreeBank (The Penn Chinese Treebank Project, 2000).

(2) a.

[symbol]

Zhangsan told Lisi that Wangwu has come.

b. (IP (NP-PN-SBJ (NR [symbol] ))

(VP (VV [symbol] [symbol] )

(NP-PN-OBJ (NR [symbol] ))
(IP (NP-PN-SBJ (NR [symbol] ))

(VP (VV [symbol] )

(AS [symbol] )))))

(IP (NP-PN-SBJ (NR Zhangsan))

(VP (VV tell)

(NP-PN-OBJ (NR Lisi))
(IP (NP-PN-SBJ (NR Wangwu))

(VP (VV come)

(AS le))))))

The Penn Chinese TreeBank provides solid linguistic analysis for the selected text, based on the current research in Chinese syntax and the linguistic expertise of those involved in the Penn Chinese Treebank project to annotate the text manually.

Another approach to parse natural language sentences is based on shallow parsing which is an inexpensive, fast and reliable procedure. Shallow parsing (or chunking) does not deliver full syntactic analysis but is limited to parsing smaller constituents such as noun phrases or verb phrases (Abney, 1996). For example (3), the sentence (3a) can be processed as follows:

| | | |
|---|---|---|
| (3) a. | [symbol] | (Chinese) |
| | wo xiang shenqing gui gongsi de dianzixinxiang | (Pin Yin) |
| | I want apply your company's e-mailbox | (word-to-word) |
| | I want to apply an e-mailbox of your company. | (English) |
| b. | [ [symbol] (N) [symbol] (Vt) [symbol] (Vt) [symbol] (N) [symbol] (De) [symbol] (N)] | |
| | [I(N) want(Vt) apply(Vt) your-company(N) e-mailbox (N)] | |
| c. | [NP [symbol] ] [VP [symbol] ] [NP [symbol] ]] | |
| | [NP I] [VP want to apply] [NP e-mailbox of your company] | |

In (3b), ‘N’ denotes a noun and ‘Vt’ denotes a transitive verb. In (3c), there are three chunks which are two NP chunks and one VP chunk generated. A chunk consists of syntactically correlated parts of words in sentences.

The present invention is a method for processing Chinese sentences which can automatically transform a Chinese sentence into a Triple representation based on shallow parsing without manually annotating every sentence. Our method is concerned with parsing Chinese sentences by employing lexical and partial syntactical information to extract more prominent entities in a Chinese sentence, and the sentence is then transformed into a Triple representation. The lexical and syntactical information in our method is referring a lexicon possessing part-of-speech (POS) information and phrase-level syntax in Chinese respectively. The Triple representation consists of three elements which are agent, predicate, and patient in a sentence.

### BRIEF DESCRIPTION OF THE DRAWINGS

FIG. 1 is a flow chart of this patent illustrating the procedure of the method for processing Chinese sentences;

FIG. 2 is a block diagram illustrating the detailed procedure of phrase-level parsing in Chinese;

FIG. 3 is a block diagram illustrates the detailed procedure of Triple transformation.

### DETAILED DESCRIPTION OF THE INVENTION

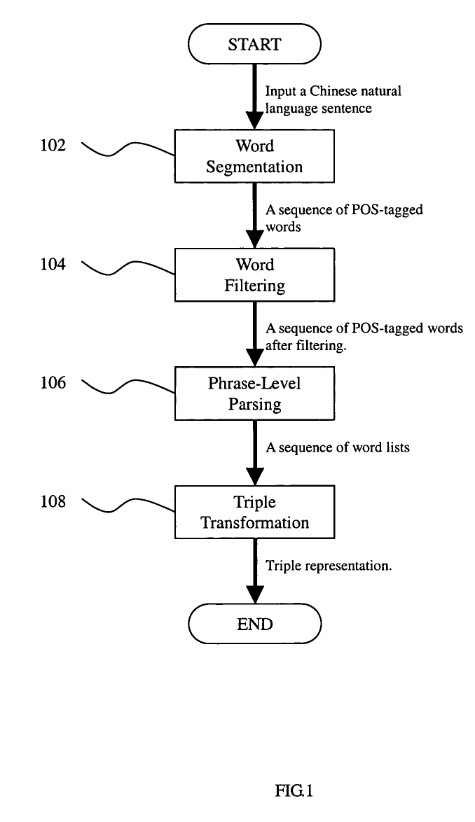

The invention of the method for processing Chinese sentences is divided into several steps as shown in FIG. 1. First the step 102 is to divide a sentence into a sequence of POS-tagged words according to the rule of the longest word prioritized first. In the step 104, the sequence of words is filtered out the words having POS other than Noun, Verb, and Preposition. The step 106 is to parse smaller constituents such as noun phrases or verbal phrases. In the step 108, these constituents are grouped and transformed into Triple representation.

The rule of the longest word prioritized first is a simple and easy-to-implement rule, which is described as follows: Given a lexicon having POS information and a Chinese sentence, the leading sub-strings are compared with the entries in the lexicon. Then the longest word in the matched sub-strings is selected and the remaining sub-string becomes the string to be matched in the next round of matching until the remaining sub-string is empty. In the step of word filtering (104), based on observations on real Chinese texts, the part of speech of most important words are nouns and verbs. Therefore, the words having POS of Noun and Verb are kept, and besides, the prepositions are also reserved for the predicates other than verbs between noun phrases. For example (4), the relation sentence (4a) can be processed as (4b):

| | | |
|---|---|---|
| (4)a. | [symbol] | (Chinese) |
| | zhangsan zai gongyuan | (Pin Yin) |
| | Zhangsan in park | (word-to-word) |
| | Zhangsan is in the park. | (English) |
| b. | [[ [symbol] ], [ [symbol] ], [ [symbol] ]] | |
| | [[Zhangsan], [is-in], [park]] | |

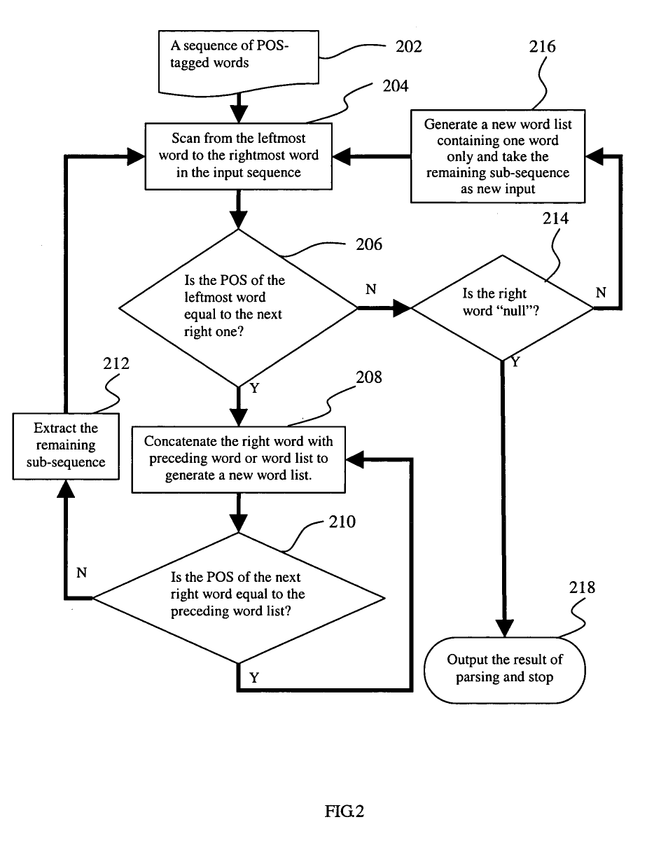

For parsing smaller constituents such as noun phrases or verbal phrases in a Chinese sentence, the FIG. 2 illustrates the detailed procedure of phrase-level parsing. The input is a sequence of POS-tagged words (202) after word filtering. The step 204 begins to scan from the leftmost word in the sequence and then the step 206 checks whether the POS of the leftmost word is equal to the POS of next right word. If the answer is yes, a new word list consisting of these words with the same POS is generated in the step 208. After the word list is generated, the step 210 checks if the POS of the following word is equal to POS of the preceding word list, and keep on running the step of concatenation (208) until the unequal POS occurs. The step 212 extracts the remaining sub-sequence and goes to the step 204 to start another phrase parsing. The step 214 checks the remaining sub-sequence, and if no other word is left to be processed, the procedure stops (218). Otherwise, a word list containing only one word is generated (216), and then goes to the step 204 for processing the remaining sub-sequence. The procedure is a phrase-level parsing to generate a sequence of word lists including noun phrases and verb phrases. The example (5a) shows the output of the phrase-level parsing.

| | | |
|---|---|---|
| (5) a. | [symbol] | (Chinese) |
| | lisi de pengyou xianggou mai women gongsi de dianzixinxiang | (Pin Yin) |
| | Lisi's friend want buy we company's e-mailbox | (word-to-word) |
| | Lisi's friend wants to buy an e-mailbox of our company. | (English) |
| b. | [[np,[ [symbol] ]] [vp, [ [symbol] ]] [np [ [symbol] ]]] | |
| | [[np,[Lisi,friend]] [vp, [want,buy]] [np [our,company,e-mailbox]]] | |
| c. | [[ [symbol] ], [ [symbol] ], [ [symbol] ]] | |
| | [[Lisi,friend]], [want,buy], [our,company,e-mailbox]] | |

The present invention proposes a Triple representation, [A, Pr, Pa], which consists of three elements—agent, predicate, and patient—corresponding to subject, verb/preposition, object in a clause or a sentence. The three elements, A, Pr and Pa, are three word lists enclosed in square brackets [ ], as shown in (5c). In the steps 102, 104 and 106, a sentence is processed into a sequence of word lists consisting of prominent words like (5b). Because Chinese is a SVO (Subject-Verb-Object) language (Li and Thompson, 1981), the simple syntax is employed to transform the output of phrase-level parsing into the Triples. The definition of Triple representation is illustrated in Definition 1.

Definition 1:
A Triple T is characterized by a 3-tuple:
T=[A, Pr, Pa] where
A is a list of nouns enclosed in square brackets [ ] whose grammatical role is the subject of a clause.
Pr is a list of verbs or a preposition enclosed in square brackets [ ] whose grammatical role is the predicate of a clause.
Pa is a list of nouns enclosed in square brackets [ ] whose grammatical role is the object of a clause.

As illustrated in Definition 1, the Triple is a simple representation which consists of three elements: A, Pr and Pa which correspond to the Subject (noun phrase), Predicate (verb phrase) and Object (noun phrase) respectively in a clause. No matter how many clauses within the Chinese sentences, the Triples will be extracted in order. For example (6), there are two Triples in (6b). In the second Triple of (6b), zero denotes a zero anaphor, which often occurs in Chinese texts.

| | | |
|---|---|---|
| (6) a. | [symbol] | (Chinese) |
| | zhangsan canjia bisai yingde yi tai diannao | (Pin Yin) |
| | Zhangsan enter competition win a computer | (word-to-word) |
| | Zhangsan entered a competition and won a computer. | (English) |
| b. | [[[ [symbol] ], [ [symbol] ], [ [symbol] ]], [[zero], [ [symbol] ], [ [symbol] ]]] | |
| | [[[Zhangsan], [enter], [competition]], [[zero], [win], [computer]]] | |

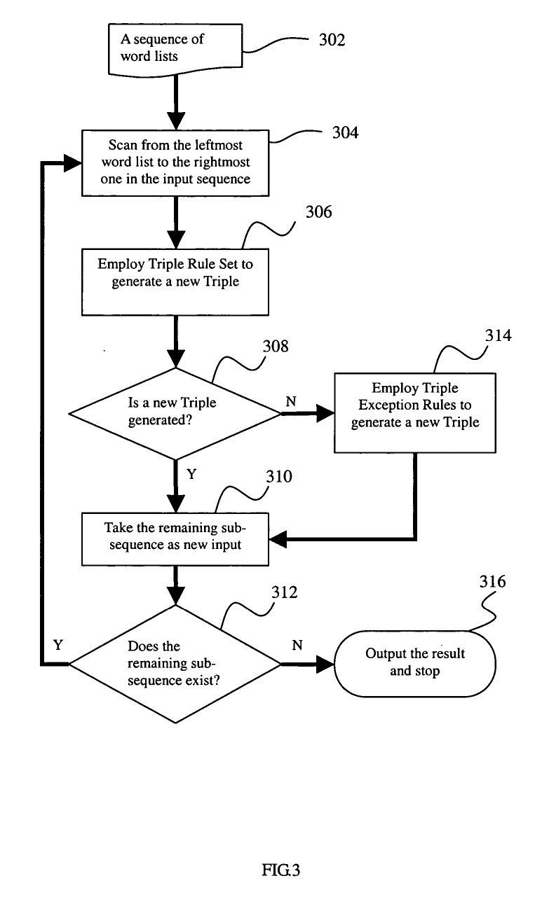

The FIG. 3 illustrates the detailed procedure of Triple transformation. The input is a sequence of word lists (302) after shallow parsing. The step 304 begins to scan from the leftmost word list in the sequence and then the step 306 employs the Triple Rule Set to generate a new Triple. In the step 308, if a new Triple is generated, the step 310 takes the remaining sub-sequence as a new input, or the step 314 employs the Triple Exception Rules to generate a new Triple. The step 312 checks whether the remaining sub-sequence exists, and if no other word list is left to be processed, the procedure stops, or otherwise, goes to the step 304 for processing the remaining sub-sequence.

The Triple Rule Set is built by referring to the Chinese syntax. There are five kinds of Triples in the Triple Rule Set, which corresponds to five basic clauses: subject+transitive verb+object, subject+intransitive verb, subject+preposition+object, preposition+noun phrase, and a noun phrase only. The rules listed below are employed in order:

Triple Rule Set:

Triple1(A,Pr,Pa)→np(A), vtp(Pr), np(Pa).

Triple2(A,Pr,none)→np(A), vip(Pr).

Triple3(A,Pr,Pa)→np(A), prep(Pr), np(Pa).

Triple4(none,Pr,Pa)→prep(Pr), np(Pa).

Triple5(A,none,none)→np(A).

The vtp(Pr) denotes the predicate is a transitive verb phrase, which contains a transitive verb in the rightmost position in the phrase; likewise the vip(Pr) denotes the predicate is an intransitive verb phrase, which contains an intransitive verb in the rightmost position in the phrase. In the rule Triple3, the prep(Pr) denotes the predicate is a preposition. If all the rules in the Triple Rule Set failed, the Triple Exception Rules referring to the phenomenon of zero anaphora in Chinese is utilized:

Triple Exception Rules:

Triple1^{e1}(zero,Pr,Pa)→vtp(Pr), np(Pa).

Triple1^{e2}(A,Pr,zero)→np(A), vtp(Pr).

Triple1^{e3}(zero,Pr,zero)→vtp(Pr).

Triple2³(zero,Pr,none)→vip(Pr).

The zero anaphora in Chinese generally occurs in the topic, subject or object position. The rules Triple1^{e1}, Triple1^{e3}, and Triple2^{e} reflect the zero anaphora occurs in the topic or subject position. The rule Triple1^{e2} reflects the zero anaphora occurs in the object position.

### REFERENCE

Steven Abney. 1996. Tagging and Partial Parsing. In: Ken Church, Steve Young, and Gerrit Bloothooft (eds.), Corpus-Based Methods in Language and Speech. An ELSNET volume. Kluwer Academic Publishers, Dordrecht.
James Allen. Natural Language Understanding 2^{nd} ed. The Benjamin/Cummings Publishing Company, Inc., 1995.
F.-Y. Chen, P.-F. Tsai, K.-J. Chen, and C.-R. Huang. 1999. Sinica Treebank. Computational Linguistics and Chinese Language Processing (CLCLP), 4(2): 87-104.
Yan Huang. 1994. The Syntax and Pragmatics of Anaphora—A study with special reference to Chinese, Cambridge University Press.
Charles N. Li and Sandra A. Thompson. 1981. Mandarin Chinese—A Functional Reference Grammar, University of California Press.
Sinica Treebank. 2002. URL http.//turing.iis.sinica.edu.tw/treesearch/, Academia Sinica.
The Penn Chinese Treebank Project. 2000. URL http://www.cis.upenn.edu/˜chinese/. Linguistic Data Consortium, University of Pennsylvania.
XUE, N., XIA, F., HUANG, S., and KROCH, A. 2000. The bracketing guidelines for the Penn Chinese Treebank (draft II). Technical report, University of Pennsylvania.
Ching-Long Yeh and Yi-Chun Chen. 2003. Zero Anapoora Resolution in Chinese with Partial Parsing Based on Centering Theory. Proceedings of NLP-KE03, Beijing, China.

1. A method of processing Chinese natural language sentence comprising the steps of: segmenting a Chinese natural language sentence into a sequence of POS(part of speech)-tagged words;
filtering out unnecessary words from a sequence of POS-tagged words;
employing phrase-level parsing techniques to parse and extract each phrase as a word list in a sequence of POS-tagged words;
transforming a sequence of word lists into Triple representation.

2. The method of claim 1, wherein the step of filtering out unnecessary words includes filtering out the words having POS other than Noun, Verb, and Preposition.

3. The method of claim 1, wherein the step of employing phrase-level parsing techniques to parse and extract phrases includes parsing noun phrases and verb phrase as word lists in a sequence of POS-tagged words.

4. The method of claim 3, wherein word lists extracted further comprises the word lists containing only prepositions.

5. The method of claim 1, wherein the step of transforming a sequence of word lists into Triple representation employs the Triple Rule Set and Triple Exception Rules.

6. The method of claim 5, wherein the Triple Rule Set contains five rules which corresponds to five basic Chinese clauses listed below:
subject+transitive verb+object,
subject+intransitive verb,
subject+preposition+object,
preposition+noun phrase,
a noun phrase.

7. The method of claim 5, wherein the Triple Exception Rules contain five rules which corresponds to four basic Chinese clauses listed below:
zero anaphor+transitive verb+object,
subject+transitive verb+zero anaphor,
zero anaphor+transitive verb+zero anaphor,
zero anaphor+intransitive verb,

8. The method of claim 5, wherein the Triple Exception Rules contains rules for processing the problem of zero anaphora, which occurs in topic, subject or object position in Chinese.

9. The method of claim 5, wherein the Triple Exception Rules is employed if all the rules in the Triple Rule Set failed.

10. A method of translating a Chinese clause into Triple representation, which is characterized by a 3-tuple containing subject, predicate and object of a clause in order.

11. The method of claim 10, wherein a Triple represents a Chinese clause.

12. The method of claim 10, wherein the second element of a Triple represents the relation between the subject and object of a Chinese clause when they both appear in a clause.

13. The method of claim 12, wherein the relation is a list of verbs or a preposition between the subject and object.

14. The method of claim 10, wherein the elements of a Triple are [zero] or [none] if the subject, predicate or object does not appear in a clause.

15. The method of claim 14, wherein the [zero] denotes a zero anaphor.

16. A method of transforming each clause of a Chinese sentence into Triples in order.

17. The method of claim 16, wherein a Chinese sentence is parsed from the leftmost word to the rightmost one and transformed into the Triples by employing the Triple Rule Set and the Triple Exception Rules.
